(19) United States
(12) Patent Application Publication
(10) Pub. No.: US 2021/0261411 A1
(43) Pub. Date: Aug. 26, 2021

(54) METHOD OF MAKING ANHYDROUS METAL SULFIDE NANOCRYSTALS

(71) Applicant: Colorado School of Mines, Golden, CO (US)

(72) Inventors: Colin A. Wolden, Denver, CO (US); William H. Smith, Golden, CO (US)

(21) Appl. No.: 17/180,479

(22) Filed: Feb. 19, 2021

Related U.S. Application Data
(60) Provisional application No. 63/023,550, filed on May 12, 2020.
(60) Provisional application No. 62/980,015, filed on Feb. 21, 2020.

(51) Int. Cl. C01B 17/40

(52) U.S. Cl. CPC C01B 17/40; C01P 2004/64; C01P 2002/72

(57) ABSTRACT

Methods of forming Li₂S and other MSₙ nanocrystals are provided. The methods employ low-cost lithium salts as a reagent and utilizes one or more metathesis reactions that occur either in solution, preferably at or near ambient conditions, or in the solid-state at elevated temperatures.

### CROSS REFERENCE TO RELATED APPLICATIONS

This application claims the benefit of priority under 35 U.S.C. § 119(e) to U.S. Provisional Patent Application 62/980,015 filed Feb. 21, 2020 and to U.S. Provisional Patent Application 63/023,550 filed May 12, 2020. The entirety of these applications is incorporated herein by reference.

### GOVERNMENT RIGHTS

This invention was made with government support under grant number 1825470 awarded by National Science Foundation. The government has certain rights in the invention.

### FIELD OF THE INVENTION

The present disclosure relates to improved methods of making anhydrous metal sulfide nanocrystals.

### BACKGROUND

Metal chalcogenide (MYₙ, where Y=S, Se, and Te) nanocrystals have attracted a great deal of attention for a wide range of applications including next generation batteries, catalysts, semiconductors, and advanced lubricants. Table 1 provides several examples of metal chalcogenides and some of their various applications. However, while metal chalcogenides are promising materials, their practical deployment in these various applications is highly constrained by both costs and the ability to control their morphology. Conventional production techniques include chemical vapor deposition, carbothermal reduction, elemental conversion, and hydrothermal synthesis. These processes are not amenable to scale-up, are energy intensive, and suffer from poor yields.

TABLE 1
Applications for various metal chalcogenides.

| | Semiconductors | | |
|---|---|---|---|
| Advanced Batteries | (quantum dot, | Catalysts | |
| (solid-state | detector, field | (electro-, | Lubricants, |
| electrolytes, Cathodes | effect transistor) | photo-) | Fullerene-like |
| Li₂S, Na₂S GeS₂, | SnS₂, ZrS₂, CdS, | SnS₂, ZrS₂, | TiS₂, SnS₂, |
| SiS₂, TiS₂, SnS₂, | ZnS, CdTe | VS₂, MoS₂, | MoS₂, WS₂ |
| MoS₂ | | WS₂ | |

In particular, anhydrous lithium sulfide (Li₂S) has great potential for use in both lithium-sulfur (Li—S) and all solid-state batteries (ASSB). Li₂S may be employed directly as a cathode material in Li—S batteries and is the key component and cost driver in the production of lithium supertonic conducting (LISICON) solid-state electrolytes (SSE) including as Li₁₀GeP₂S₁₂, Li₇P₃S₁₁, and argyrodites (Li₆PS₅X, where X=Cl, Br, and I). Li₂S currently retails for $1000/kg in bulk and up to $15,000/kg for lab scale quantities, making potential battery technologies that rely on this material prohibitively expensive and uncompetitive. This cost reflects, in part, current synthetic techniques.

Synthetic techniques for producing Li₂S at large scale include carbothermal reduction of lithium sulfate:

Li₂SO₄₍ₛ₎+2C₍ₛ₎→Li₂S₍ₛ₎+2CO_{2(g)}. (1)

This highly endothermic reaction requires temperatures >800° C. and releases significant quantities of greenhouse gases. This information is set forth in: N. Ikeda and K. Yamamoto, “Method of manufacturing lithium sulfide,” EP 0802159 B1, 2001; and M. Kohl, J. Bruckner, I. Bauer, H. Althues, and S. Kaskel, “Synthesis of highly electrochemically active Li₂S nanoparticles for lithium-sulfur-batteries”, J. Mater. Chem. A 3, 16307 (2015) (each of which are incorporated herein in their entirety).

An alternative method is the hydrosulfurization of LiX salts (X=OH, Cl, Br, etc.):

2LiX₍ₛ₎+excess H₂S_{(g)}→Li₂S₍ₛ₎+2HX_{(g)}+H₂S_{(g)}. (2)

This reaction is also endothermic and requires elevated temperatures, though somewhat lower temperatures than the carbothermal reduction method described above. Depending on the precursor, the temperature varies from 100-500° C., with LiOH being the most reactive. Lithium carbonate (Li₂CO₃) reacts similarly but requires much higher temperatures. This information is set forth in: EP 0802159 B1; and C. B. Dressel, H. Jha, A.-M. Eberle, H. A. Gasteiger, and T. F. Fässler, “Electrochemical performance of lithium-sulfur batteries based on a sulfur cathode obtained by H₂S gas treatment of a lithium salt”, J. Power Sources 307, 844-848 (2016) (which is incorporated herein in its entirety). This process requires the handling of the hazardous H₂S at elevated temperature as well as the generation of additional corrosive species (e.g., HCl, etc.)

For battery applications, the size and uniformity of the resulting Li₂S powders is important to the success of subsequent processing. Material produced in the processes described above often results in particles that are too large for use in battery applications, mandating the use of energy-intensive and time-consuming ball milling to reduce the particle size. Ball milling is effective in reducing the average particle size but does little to improve uniformity of the particles and creates the possibility of contamination from the media employed.

As an alternative, Li₂S may be synthesized in a solution-based approach. In this two-step process, metallic lithium is first dissolved in alcohol, forming an alkoxide precursor and releasing valuable hydrogen gas:

2Li₍ₛ₎+2ROH₍ₛₒₗ₎→2ROLi₍ₛₒₗ₎+H_{2(g)}. (3)

Next H₂S diluted in an inert gas is bubbled through the solution to produce Li₂S and regenerate the alcohol:

2ROLi₍ₛₒₗ₎+H₂S_{(g)}→Li₂S₍ₛₒₗ₎+2ROH₍ₛₒₗ₎. (4)

H₂S is supplied in a stoichiometric amount and is completely abated in the process. Both of these thermodynamically favorable reactions proceed spontaneously and rapidly go to completion at room temperature. The Li₂S may either precipitate out of solution directly or may be recovered by evaporation, depending on the choice of co-solvent. The net reaction is:

2Li₍ₛ₎+H₂S_{(g)}→Li₂S₍ₛ₎+H_{2(g)}. (5)

This process offers numerous advantages including abatement of a major industrial waste gas (H₂S) and the co-generation of two high value products (H₂ and Li₂S) that are easily separated and recovered. It has a low energy budget and the alcohol reagent may be recovered and recycled. This information is set forth in: Y. Yang, C. A. Wolden, X. Li, and R. Morrish, “Production of alkali sulfide cathode material and methods for processing hydrogen sulfide”, U.S. Pat. No. 10,399,853 issued Sep. 3 2019; X. Li, Y. Zhao, A. Brennan, M. McCeig, C. A. Wolden, and Y. Yang, “Reactive precipitation of anhydrous alkali sulfide nanocrystals with concomitant abatement of hydrogen sulfide and cogeneration of hydrogen”, Chem Sus Chem 10, 2904 (2017); Y. Zhao, Y. Yang, and C. A. Wolden, “Scalable synthesis of size-controlled Li₂S nanocrystals for next-generation battery technologies”, ACS Appl. Energy Mater. 2, 2246 (2019); K. Hietala, Y. Zhao, Y. Yang, and C. A. Wolden, “Scalable synthesis of alkali sulfide nanocrystals using a bubble column reactor”, Ind Eng. Chem. Res. 57, 8436 (2018); and Y. Zhao, W. Smith, and C. A. Wolden, “Scale-up of Li₂S nanocrystal synthesis and application to solid state electrolytes”, J. Electrochem. Soc, 167, 070520 (2020) (each of which are incorporated herein in their entirety). However, while this process is thermodynamically favorable, it is still cost prohibitive as it requires the use of metallic lithium, which is 2-5 times more expensive on a lithium basis than the leading lithium battery precursors (e.g., Li₂CO₃, LiCl, and LiOH). Moreover, metallic lithium is pyrophoric and therefore requires careful handling in an expensive glove box environment, and the use of hazardous H₂S remains a concern.

### SUMMARY

The present invention provides alternative methods to synthesis Li₂S and other metal or metalloid sulfide (MSₙ) nanocrystals with significant advantages over the known processes described above.

One method disclosed herein is a solution-based process that employs low-cost lithium salts as a reagent and utilizes one or more metathesis reactions that are preferably spontaneous at ambient or near ambient conditions and that proceed rapidly to completion with near 100% efficiency. The products are readily phase-separated from the organic solution, which may then be recovered and recycled. The method advantageously produces Li₂S nanocrystals having a morphology and particle size distribution suitable for use in battery applications, eliminating the need for further process steps.

Another method disclosed herein involves the same reagents but the metathesis reaction is conducted in the solid-state at elevated temperature without solvent. The resulting products are then phase separated in organic solution, retaining the ability to maintain control over Li₂S crystal size and morphology.

The methods disclosed herein comprise mixing a first sulfide salt and a first lithium salt; allowing sufficient time to form Li₂S and a product salt; and recovering the Li₂S. In some embodiments, the first sulfide salt and the first lithium salt are mixed in a solution. The product salt is insoluble in or only sparingly soluble in the solution and the product salt is separated from the solution prior to recovering the Li₂S. The solution may comprise a polar solvent having a boiling point of about 150° C. or less, and Li₂S may be recovered via solvent evaporation in an inert atmosphere or in the presence of H₂S. In some preferred embodiments, the first sulfide salt and the first lithium salt spontaneously react to form the Li₂S at room temperature.

In other embodiments, the first sulfide salt and the first lithium salt are mixed, without the addition of a solvent, and the mixture is heated to a temperature of at least 400° C. The Li₂S and the product salt are added to a solution in which the product salt is insoluble in or only sparingly soluble in and the product salt is separated from the solution prior to recovering the Li₂S. The first solution may comprise a polar solvent having a boiling point of about 150° C. or less, and Li₂S may be recovered via solvent evaporation in an inert atmosphere or in the presence of H₂S.

In some embodiments, the method further comprises annealing the recovered Li₂S at a temperature of about 150° C. to about 300° C. in an inert atmosphere or in the presence of H₂S.

In some embodiments, the Li₂S is in the form of nanocrystals have a volume-averaged mean particle size (D₅₀) from 5 nm to 50 nm.

In some embodiments, the first sulfide salt is selected from the group consisting of Na₂S, K₂S, Rb₂S, Cs₂S, Fr₂S, (NH₄)₂S, P₂S₅, NiS, and combinations thereof.

In some embodiments, the first lithium salt is selected from the group consisting of a lithium halide, lithium hydroxide (LiOH), lithium carbonate (Li₂CO₃), lithium sulfate (Li₂SO₄), lithium sulfite (Li₂SO₃), lithium amide (LiNH₂), lithium nitride (LiN₃), lithium nitrate (LiNO₃), lithium phosphate (Li₃PO₄), and combinations thereof.

In an aspect of the invention, the Li₂S produced in either of the two approaches described above can then be used as a reactant for the metathesis of additional sulfides. This reaction regenerates the lithium salt, which can then be used to produce additional Li₂S. In other words, the lithium salt is not consumed but is simply a reactive intermediate that facilitates the synthesis of other desired metal or metalloid sulfides. This circular process is described as cascaded metathesis.

In some embodiments, the method further comprises mixing the recovered Li₂S and a non-lithium containing salt; allowing sufficient time to form a metal or metalloid sulfide (MSₙ) and a second lithium salt; and recovering the MSₙ. In some embodiments, the recovered Li₂S and non-lithium containing salt are mixed in a solution. The MSₙ is insoluble in or only sparingly soluble in the solution and MSₙ is separated from the solution. The solution may comprise a polar aprotic solvent having a boiling point of about 150° C. or less.

In other embodiments, the recovered Li₂S and non-lithium containing salt are mixed, without the addition of a solvent, and the mixture is heated to a temperature of at least 400° C. MSₙ and the product salt are added to a solution in which MSₙ is insoluble in or only sparingly soluble in and it is separated from the solution. The solution may comprise a polar aprotic solvent having a boiling point of about 150° C. or less.

In some embodiments, the non-lithium containing salt comprises a metal or metalloid cation and an anion selected from the group consisting of a halide, hydroxide, carbonate, sulfate, sulfite, nitrate, nitrite, phosphate, acetate, citrate, and combinations thereof.

In some embodiments, MSₙ is selected from the group consisting of Cr₂S₃, MnS, ReS₂, FeS₂, RuS₂, OsS₂, CoS₂, RhS₂, IrS₃, NiS₂, PdS, PtS, HfS₂, NbS₂, TaS₂, GeS₂, SiS₂, TiS₂, SnS₂, MoS₂, ZrS₂, CdS, ZnS, VS₂, WS₂, Al₂S₃, CaS, and MgS.

In some embodiments, the method further comprises recovering the second lithium salt and recycling the second lithium salt second to be used as the first lithium salt.

This Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention, and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. In addition, all ranges described herein may be reduced to any sub-range or portion of the range.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below.

FIG. 1 is a schematic illustrating cascaded metathesis of metal or metalloid sulfide nanocrystals.

FIG. 2 is an XRD pattern (top) of precipitate recovered from solution using the solution-based metathesis approach described herein. The literature peaks for NaCl (bottom) are shown as well.

FIG. 3 is an XRD pattern (top) of the solids recovered from the supernatant using the solution-based metathesis approach described herein. The literature peaks for Li₂S (bottom) are shown as well.

FIG. 4 is an XRD pattern of the solid-state metathesis products obtained as a function of temperature. The peaks associated with LiCl (•), Na₂S (♦), NaCl (▴), and Li₂S (▪) are identified in legend.

FIG. 5 is an XRD pattern of the products recovered from solution after dissolving the solid-state products formed as a function of temperature. The reference pattern of Li₂S (bottom) is provided, and the peaks associated with LiOH (♦) are identified in legend.

### DETAILED DESCRIPTION

Disclosed herein are methods of producing Li₂S and other metal or metalloid sulfide (MSₙ) nanocrystals. In some embodiments, Li₂S is a final reaction product. In other embodiments, Li₂S is an intermediate and is reacted to form other metal or metalloid sulfide nanocrystals.

An aspect of the invention is a method of producing Li₂S nanocrystals. The process involves mixing a sulfide salt and a lithium salt in one or more solvents. The sulfide salt may be an alkali metal sulfide salt (M₂S, where M=Na, K, Rb, Cs, and Fr) or another sulfide salt, such as, by way of non-limiting example, (NH₄)₂S, P₂S₅, and NiS. The lithium salt may be a lithium halide such as LiF, LiCl, LiBr, and LiI, or another lithium salt, such as, by way of non-limiting example, LiOH, LiNH₂, LiN₃, and LiNO₃. These salts are represented by the formula LiX, where X is an anion with a formal charge of −1. Other suitable lithium salts may be Li₂CO₃, Li₂SO₄, and Li₂SO₃. These salts are represented by the formula Li₂X, where X is an anion with a formal charge of −2. Another suitable lithium salt may be Li₃PO₄. Li₂S is formed via a metathesis or counter-ion exchange reaction in a suitable solvent. Two general reactions to produce Li₂S are:

2LiX+M₂→Li₂S+2MX (6); and

Li₂X+M₂→Li₂S+M₂X. (7)

In an embodiment, the method comprises: preparing a solution comprising the sulfide salt; preparing a solution comprising the lithium salt; mixing the two solutions; and allowing sufficient time for the reaction to form Li₂S and a product salt (MX or M₂X). In another embodiment, the method comprises: preparing a solution of one of the sulfide salt or the lithium salt; adding the other of the sulfide salt or the lithium salt to the solution; and allowing sufficient time for the reaction to form Li₂S and the product salt.

In embodiments, the formation of Li₂S occurs spontaneously at low temperatures (i.e., temperatures of about 50° C. or less) and is ideally spontaneous under ambient or room temperatures (i.e., about 18° C. to about 28° C.). In some embodiments, the sulfide salt and the lithium salt spontaneously react to form Li₂S at a temperature of about 50° C. or less, at a temperature of about 45° C. or less, at a temperature of about 40° C. or less, at a temperature of about 35° C. or less, at a temperature of about 30° C. or less, at a temperature of about 25° C. or less, at a temperature of about 20° C. or less, at a temperature of about 15° C. or less, at a temperature of about 10° C. or less, at a temperature of about 5° C. or less, at a temperature of about 0° C. or less, at a temperature of about −5° C. or less, at a temperature of about −10° C. or less, at a temperature of about −15° C. or less, at a temperature of about −20° C. or less, at a temperature of about −25° C. or less, at a temperature of about −30° C. or less, at a temperature of about −35° C. or less, at a temperature of about −40° C. or less, at a temperature of about −45° C. or less, at a temperature of about −50° C. or less, at a temperature of about −55° C. or less, at a temperature of about −60° C. or less, at a temperature of about −65° C. or less, or at a temperature of about −70° C. or less. In some embodiments, the reaction may be performed under ambient conditions (i.e., at room temperature). In some embodiments, the solution may be heated to a temperature of about 50° C., to a temperature of about 45° C., to a temperature of about 40° C., to a temperature of about 35° C., or to a temperature of about 30° C. In other embodiments, the solution may be cooled to a temperature of about 15° C., to a temperature of about 10° C., to a temperature of about 5° C., to a temperature of about 0° C., to a temperature of about −5° C., to a temperature of about −10° C., to a temperature of about −15° C., to a temperature of about −20° C., to a temperature of about −25° C., to a temperature of about −30° C., to a temperature of about −35° C., to a temperature of about −40° C., to a temperature of about −45° C., to a temperature of about −50° C., to a temperature of about −55° C., to a temperature of about −60° C., to a temperature of about −65° C., or to a temperature of about −70° C.

The reaction products, the Li₂S and the product salt, may be separated from the solvent using standard chemical methods. For instance, depending upon the solvent or co-solvents, Li₂S may either be precipitated from the solution upon formation or recovered via solvent evaporation. In some embodiments, the product salt is only sparingly soluble in the solvent and may be precipitated from the solution upon formation and then separated from the solvent by settling, centrifugation, filtration, decantation, or other suitable techniques. As used herein, “sparingly soluble” means that it requires about 1 to 2 L of the solvent to dissolve about 1 g the solute. The Li₂S may then be recovered from the solvent via solvent evaporation once the product salt has been separated. The recovered Li₂S may be in the form of nanocrystals. The evaporation process may be conducted at temperatures above the boiling point of the solvent and preferably less than about 150° C. The evaporation process may be conducted under an inert atmosphere, in the presence of H₂S, or under reduced pressure. The solvent may be captured and reused in the process.

The sulfide salt is preferably in an anhydrous form. Examples of suitable sulfide salts include, but are not limited to Na₂S, K₂S, Rb₂S, Cs₂S, Fr₂S, (NH₄)₂S, P₂S₅, NiS, and combinations thereof. In an embodiment, the sulfide salt is anhydrous Na₂S, which can be made in a number of ways. Sodium sulfide is typically sold commercially as hydrate flakes which may contain approximately 40% water by weight. The commercial Na₂S.xH₂O may be dehydrated before use in reaction or perhaps in situ through the addition of hygroscopic compounds (e.g., CaSO₄, molecular sieves, etc.). The Na₂S may also be purified by reaction at elevated temperature, for example by reaction with H₂, carbon, H₂S, and/or S₈. Therefore, anion impurities other than sulfide S²⁻ (e.g., SO₃²⁻, S₂O₃²⁻, SO₄²⁻, HS⁻, Sₓ²⁻, OH⁻) can be removed.

The lithium salt is also preferably in an anhydrous form. The lithium salt may have a general formula of LiX, Li₂X, or Li₃X where X is a singly, doubly, or triply charged anion, respectively. Examples of suitable lithium salts include, but are not limited to, LiF, LiCl, LiBr, LiI, LiOH, LiNH₂, LiN₃, and LiNO₃ Li₂CO₃, Li₂SO₃, Li₂SO₄, Li₃PO₄, and combinations thereof. In an embodiment, the lithium salt is anhydrous LiCl.

The one or more solutions may contain any suitable solvent or mixture of solvents to dissolve the reactants, facilitate the reaction to form the Li₂S, and also their recovery. The solvent may contain one or more co-solvents. In some embodiments, the solvent may be chosen such that the product salt (2MX or M₂X) is not soluble or is only sparingly soluble therein, while Li₂S is soluble therein. In other embodiments, the solvent may be chosen such that Li₂S is not soluble or are only sparingly soluble therein, while the product salt is soluble therein. In embodiments, the solvent comprises one or more volatile organic compounds that preferably have a boiling point of less than about 150° C. The solvent is preferably substantially free of water. In some embodiments, the solvent is selected from the group consisting of alcohols, ethers, esters, ketones, amides, and combinations thereof. Suitable solvents and co-solvents of the present invention include, by way of non-limiting example, C₂-C₅ alcohols, tetrahydrofuran (THF), dimethylformamide (DMF), and acetonitrile. In preferred embodiments, the solvent is a polar solvent such as an alcohol, preferably one or more of ethanol, isopropanol, propanol, butanol, and combinations thereof; these solvents may aid in the precipitation of the product salt from the solution.

The sulfide salt and the lithium salt are mixed together in solution and allowed to react for a sufficient amount of time such that the reaction produces Li₂S and a product salt. In certain embodiments, the mixture contains approximately stoichiometric amounts of the sulfide salt and the lithium salt. In some embodiments, the mixture is stirred or agitated for a portion of or all of the reaction time, which may be between about 0 minutes to about 48 hours, between about 0 minutes to about 36 hours, between about 0 minutes to about 30 hours, between about 0 minutes to about 24 hours, between about 0 minutes to about 18 hours, between about 0 minutes to about 12 hours, between about 0 minutes to about 10 hours, between about 0 minutes to about 8 hours, between about 0 minutes to about 6 hours, between about 0 minutes to about 5 hours, between about 0 minutes to about 4 hours, between about 0 minutes to about 3 hours, between about 0 minutes to about 2 hours, between about 0 minutes to about 60 minutes, between about 0 minutes to about 30 minutes, or between about 30 to about 60 minutes. The reaction time is preferably sufficient such that the reaction proceeds to completion. In some embodiments, the yield of Li₂S nanocrystals is greater than about 50%, greater than about 60%, greater than about 70%, greater than about 80%, greater than about 85%, greater than about 90%, greater than about 91%, greater than about 92%, greater than about 93%, greater than about 94%, greater than about 95%, greater than about 96%, greater than about 97%, greater than about 98%, or greater than about 99%.

In some embodiments, once Li₂S has been recovered or separated from the solution, it is then annealed. Annealing removes any residual solvent and may also improve the crystallinity and particle size distribution of the particles. Annealing is performed by subjecting the Li₂S powders to temperatures ranging from about 100° C. to about 350° C., preferably from about 150° C. to about 300° C., or more preferably from about 200° C. to about 250° C., for a sufficient period of time, for example, ranging from about 0 to 3 hours in an inert atmosphere, preferably 1 to 2 hours in an inert atmosphere.

An alternative approach to Li₂S synthesis is through a solid-state reaction at elevated temperature. The reactions are as described in (6) and (7) above, but no solvent is present. In this case stoichiometric amounts of a metal sulfide salt (MₙS) and a lithium salt (LiₙX), which are disclosed above, are mixed together and heated in an inert environment to a sufficient temperature and for a sufficient amount of time. The reaction goes to completion, producing Li₂S and the corresponding product salt. This solid-state mixture is separated by using a solvent that preferentially dissolves Li₂S, such as for example a C₂-C₅ alcohol, while the product salt remains in solid form therein. After the product salt is separated from the solvent by centrifugation, filtration, settling, decantation, or other means, Li₂S is recovered from solution by evaporating the solvent and it may also be annealed as described above.

The solution-free reaction between metal sulfide salt (MₙS) and lithium salt (LiₙX) occurs at elevated temperatures, generally above 400° C. In some embodiments, the reactants are heated to a temperature of about 450° C. or more, to a temperature of about 475° C. or more, to a temperature of about 500° C. or more, to a temperature of about 525° C. or more, to a temperature of about 550° C. or more, to a temperature of about 575° C. or more, to a temperature of about 600° C. or more, to a temperature of about 625° C. or more, to a temperature of about 650° C. or more, to a temperature of about 675° C. or more, to a temperature of about 700° C. or more, to a temperature of about 725° C. or more, to a temperature of about 750° C. or more, to a temperature of about 775° C. or more, or to a temperature of about 800° C. In some embodiments, the reactants are heated to a temperature of no more than about 800° C.

In some embodiments, the solution-free mixture is stirred or agitated for a portion of or all of the reaction time, which may be between about 0 minutes to about 180 minutes, between about 0 minutes to about 120 minutes, between about 0 minutes to about 60 minutes, between about 0 minutes to about 30 minutes, or between about 60 to about 120 minutes. The reaction time is preferably sufficient such that the reaction proceeds to completion.

The methods disclosed herein can be used to produced Li₂S nanocrystals that have a well-defined morphology and particle size distribution. As used herein, unless otherwise specified, the term “particle size” refers to a volume-averaged mean particle size as defined by X-ray scattering and diffraction, also be referred to as “D₅₀” values. The polydispersity index (PDI) is a measure of the heterogeneity of a sample based on size and is the mean size based on volume divided by the mean size based on number. In some embodiments, the Li₂S nanocrystals have a particle size of less than 100 nm. In some embodiments, the Li₂S nanocrystals have a particle size from 1 nm to 50 nm, from 1 nm to 45 nm, from 1 nm to 35 nm, from 1 nm to 30 nm, from 1 nm to 25 nm, from 1 nm to 20 nm, from 1 nm to 15 nm, from 1 nm to 10 nm, from 10 nm to 50 nm, from 15 nm to 50 nm, from 20 nm to 50 nm, from 25 nm to 50 nm, from 30 nm to 50 nm, from 35 nm to 50 nm, from 40 nm to 50 nm, from 15 nm to 45 nm, or from 20 nm to 40 nm. In some embodiments, the Li₂S nanocrystals have a PDI of 2 or less, of 1.8 or less, of 1.6 or less, of 1.4 or less, of 1.2 or less, of 1.0 or less, of 0.8 or less, of 0.6 or less, or of 0.4 or less. In some embodiments, the Li₂S nanocrystals are in the form of nanoflakes. In some embodiments the nanoflakes are arranged in cauliflower-like agglomerates.

While Li₂S is a valuable reaction product, it may also be used a precursor to form other metal or metalloid sulfide (MSₙ) nanocrystals. Another aspect of the invention is the use of Li₂S as intermediate in a series of reactions to form other metal or metalloid sulfide nanocrystals. The synthesis of these other metal or metalloid sulfide nanocrystals is performed by employing at least two metathesis or counter-ion exchange reactions. A first metathesis reaction results in the formation of Li₂S, which is then used to synthesize MSₙ nanocrystals (such as those shown in Table 1) through a second metathesis reaction with an appropriate salt (MX₂ₙ). The second metathesis reaction may be represented by:

nLi₂S+MX₂ₙ→MSₙ+2nLiX. (8)

Here M is a metal or metalloid cation and n is an integer of 1 to 4, typically either 1 or 2. Non-limiting examples of M include, Cr, Mn, Re, Fe, Ru, Os, Co, Rh, Ir, Ni, Pd, Pt, Hf, Nb, Ta, Sn, Zr, V, Mo, W, Ge, Ti, Al, Ca, Mg, Cd, Zn, and Si. The MX₂ₙ salt does not comprise lithium. The non-lithium containing salt (MX₂ₙ) comprises an anion that may be selected from the group consisting of a halide, hydroxide, carbonate, sulfate, sulfite, nitrate, nitrite, phosphate, acetate, and citrate. The non-lithium containing salt preferably is chosen such that the reaction regenerates the same lithium salt that is used in the first metathesis reaction to form Li₂S (e.g., reaction (6)).

Li₂S may be prepared according to any of the methods described above. In some embodiments, Li₂S and the non-lithium salt (MX₂ₙ) are mixed together in solution or suspension or a combination thereof and allowed to react for a sufficient amount of time such that the reaction produces MSₙ and a lithium salt. In an embodiment, the method comprises: preparing a solution comprising Li₂S; preparing a solution comprising the non-lithium salt; mixing the two solutions; and allowing sufficient time for the reaction to form MSₙ nanocrystals and the product lithium salt. In another embodiment, the method comprises: preparing a solution of one of Li₂S or the non-lithium salt; adding the other of the Li₂S or the non-lithium salt to the solution; and allowing sufficient time for the reaction to form MSₙ and the product lithium salt.

In embodiments, the formation of MSₙ is spontaneous at low temperatures (i.e., temperatures of about 50° C. or less) and is ideally spontaneous under ambient or room temperature conditions. In some embodiments, Li₂S and the non-lithium salt spontaneously react to form the MSₙ at a temperature of about 50° C. or less, at a temperature of about 45° C. or less, at a temperature of about 40° C. or less, at a temperature of about 35° C. or less, at a temperature of about 30° C. or less, at a temperature of about 25° C. or less, at a temperature of about 20° C. or less, at a temperature of about 15° C. or less, at a temperature of about 10° C. or less, at a temperature of about 5° C. or less, at a temperature of about 0° C. or less, at a temperature of about −5° C. or less, at a temperature of about −10° C. or less, at a temperature of about −15° C. or less, at a temperature of about −20° C. or less, at a temperature of about −25° C. or less, at a temperature of about −30° C. or less, at a temperature of about −35° C. or less, at a temperature of about −40° C. or less, at a temperature of about −45° C. or less, at a temperature of about −50° C. or less, at a temperature of about −55° C. or less, at a temperature of about −60° C. or less, at a temperature of about −65° C. or less, or at a temperature of about −70° C. or less. In some embodiments, the reaction may be performed under ambient conditions. In some embodiments, the solution may be heated to a temperature of about 50° C., to a temperature of about 45° C., to a temperature of about 40° C., to a temperature of about 35° C., or to a temperature of about 30° C. In other embodiments, the solution may be cooled to a temperature of about 15° C., to a temperature of about 10° C., to a temperature of about 5° C., to a temperature of about 0° C., to a temperature of about −5° C., to a temperature of about −10° C., to a temperature of about −15° C., to a temperature of about −20° C., to a temperature of about −25° C., to a temperature of about −30° C., to a temperature of about −35° C., to a temperature of about −40° C., to a temperature of about −45° C., to a temperature of about −50° C., to a temperature of about −55° C., to a temperature of about −60° C., to a temperature of about −65° C., or to a temperature of about −70° C.

In certain embodiments, the mixture contains approximately stoichiometric amounts of Li₂S and the non-lithium salt. In certain embodiments, the mixture is stirred or agitated for a portion of or all of the reaction time, which may be between about 0 minutes to about 48 hours, between about 0 minutes to about 30 hours, between about 0 minutes to about 24 hours, between about 0 minutes to about 18 hours, between about 0 minutes to about 12 hours, between about 0 minutes to about 10 hours, between about 0 minutes to about 8 hours, between about 0 minutes to about 6 hours, between about 0 minutes to about 5 hours, between about 0 minutes to about 4 hours, between about 0 minutes to about 3 hours, between about 0 minutes to about 2 hours, between about 0 minutes to about 60 minutes, between about 0 minutes to about 30 minutes, or between about 30 to about 60 minutes. The reaction time is preferably sufficient such that the reaction proceeds to completion. In certain embodiments, the yield of MSₙ is greater than about 50%, greater than about 60%, greater than about 70%, greater than about 80%, greater than about 85%, greater than about 90%, greater than about 91%, greater than about 92%, greater than about 93%, greater than about 94%, greater than about 95%, greater than about 96%, greater than about 97%, greater than about 98%, or greater than about 99%.

The reaction products, MSₙ and a lithium salt, may be separated from the solvent using standard chemical methods. For instance, depending upon the solvent or co-solvents, MSₙ may either be precipitated from the solution or recovered via solvent evaporation. In some embodiments, MSₙ is only sparingly soluble in the solvent and may be precipitated from the solution upon formation and then separated from the solution by settling, centrifugation, filtration, or other suitable techniques. The lithium product salt may then be recovered from the solvent via solvent evaporation. The lithium product salt may be recycled back to the first metathesis reaction to be used a reactant to form Li₂S (e.g., via equation (6) above). The solvent may be captured and reused in the process.

The one or more solutions for the second metathesis reaction may contain any suitable solvent or mixture of solvents to dissolve the reactants and facilitate the reaction to form and separate the MSₙ powders. The solvent may contain one or more co-solvents. In some embodiments, the solvent may be chosen such that the product lithium salt is not soluble in or is only sparingly soluble therein, while MSₙ is soluble therein. In other embodiments, the solvent may be chosen such that MSₙ is not soluble or is only sparingly soluble therein, while the lithium salt is soluble therein. In embodiments, the solvent comprises one or more volatile organic compounds that preferably have a boiling point of less than about 150° C. The solvent is preferably substantially free of water. In some embodiments, the solvent comprises alcohols, ethers, esters, ketones, amides, and combinations thereof. Suitable solvents and co-solvents of the present invention include, by way of non-limiting example, C₂-C₅ alcohols, tetrahydrofuran (THF), dimethylformamide (DMF), acetonitrile, and acetone. In preferred embodiments, the solvent is a polar aprotic solvent, preferably tetrahydrofuran (THF), dimethylformamide (DMF), acetonitrile, and acetone, and combinations thereof such solvents may aid in the precipitation of MSₙ from the solution upon formation.

In some embodiments, once the MSₙ powders have been recovered or separated from the solution, they are annealed. Annealing removes any residual solvent and may also improve the crystallinity and particle size distribution of the powders. Annealing is performed by subjecting MSₙ to temperatures ranging from about 100° C. to about 350° C., preferably from about 150° C. to about 300° C., or more preferably from about 200° C. to about 250° C., for a period of time, for example, ranging from about 0 to 3 hours in an inert atmosphere, preferably 1 to 2 hours in an inert atmosphere.

As an alternative to the solution based approach, MSₙ may also be formed through a solid-state or solvent-free reaction at elevated temperature. In this case stoichiometric amounts of Li₂S and a suitable non-lithium containing salt (MX₂ₙ), which are disclosed above, are mixed together and heated in an inert environment to sufficient temperature and for a sufficient amount of time. The reaction goes to completion, producing MSₙ and the corresponding lithium containing product salt. This solid-state mixture is separated by using a solvent that preferentially dissolves lithium containing product salt, such as for example polar aprotic solvent, while MSₙ remains in solid form therein. MSₙ may then be separated from the solvent by centrifugation, filtration, settling, decantation, or other means and the MSₙ powders may be annealed as described above. The lithium containing product salt can be recovered from solution by evaporating the solvent.

The solvent-free reaction between metal or metalloid salt (MX₂ₙ) and lithium sulfide (Li₂S) occurs at elevated temperatures, generally above 400° C. In some embodiments, the reactants are heated to a temperature of about 450° C. or more, to a temperature of about 475° C. or more, to a temperature of about 500° C. or more, to a temperature of about 525° C. or more, to a temperature of about 550° C. or more, to a temperature of about 575° C. or more, to a temperature of about 600° C. or more, to a temperature of about 625° C. or more, to a temperature of about 650° C. or more, to a temperature of about 675° C. or more, to a temperature of about 700° C. or more, to a temperature of about 725° C. or more, to a temperature of about 750° C. or more, to a temperature of about 775° C. or more, or to a temperature of about 800° C. In some embodiments, the reactants are heated to a temperature of no more than about 800° C.

In some embodiments, the solvent-free mixture is stirred or agitated for a portion of or all of the reaction time, which may be between about 0 minutes to about 180 minutes, between about 0 minutes to about 120 minutes, between about 0 minutes to about 60 minutes, between about 0 minutes to about 30 minutes, or between about 60 to about 120 minutes. In some embodiments, the reaction time is sufficient such that the reaction proceeds to completion.

The methods disclosed herein may be used to produce MSₙ nanocrystals that have a well-defined morphology and particle size distribution. In some embodiments, the MSₙ nanocrystals have a particle size of less than 100 nm. In some embodiments, the MSₙ nanocrystals have a particle size from 1 nm to 50 nm, from 1 nm to 45 nm, from 1 nm to 35 nm, from 1 nm to 30 nm, from 1 nm to 25 nm, from 1 nm to 20 nm, from 1 nm to 15 nm, from 1 nm to 10 nm, from 10 nm to 50 nm, from 15 nm to 50 nm, from 20 nm to 50 nm, from 25 nm to 50 nm, from 30 nm to 50 nm, from 35 nm to 50 nm, from 40 nm to 50 nm, from 15 nm to 45 nm, or from 20 nm to 40 nm. In some embodiments, the MSₙ nanocrystals have a PDI of 2 or less, of 1.8 or less, of 1.6 or less, of 1.4 or less, of 1.2 or less, of 1.0 or less, of 0.8 or less, of 0.6 or less, or of 0.4 or less.

The cascaded metathesis approach, may be used to produce a variety of MSₙ powders. In some embodiments, Li₂S may be formed from the reaction of Na₂S with LiCl, shown in reaction (9), in alcohol or another suitable solvent. This reaction is spontaneous at ambient temperature.

2LiCl₍ₛₒₗ₎+Na₂S₍ₛₒₗ₎→Li₂S₍ₛₒₗ₎+2NaCl₍ₛ₎ΔG°≈−90 kJ/mol (9)

A first solution may comprise less than about 12 g/100 g of Na₂S in ethanol, preferably from about 9 g/100 g to about 11.5 g/100 g of Na₂S in ethanol, and a second solution may comprise less than about 25 g/100 g of LiCl in ethanol, preferably from about 15.5 g/100 g to about 25 g/100 g of LiCl in ethanol. Stoichiometric amounts of Na₂S and LiCl may then be mixed after both have been dissolved in ethanol in the first and second solutions. The sodium chloride precipitates out of solution as it is sparingly soluble in ethanol, while Li₂S remains dissolved. The NaCl precipitate is removed from the solution by standard techniques and Li₂S is then recovered by solvent evaporation.

In other embodiments, Li₂S may be formed from the reaction of Na₂S with LiCl by heating in an inert environment. Stoichiometric amounts of Na₂S and LiCl powders may be mixed and heated to temperatures of about 600° C. under inert atmosphere. The reaction products are a mixture of NaCl and Li₂S which can be separated using ethanol, which dissolves Li₂S while NaCl is sparingly soluble. The NaCl precipitate is removed from the solution by standard techniques and the Li₂S powders can then recovered by solvent evaporation as described previously.

The recovered Li₂S may then be reacted through a second metathesis reaction with a chloride salt, as shown in reaction (10):

$${n Li}_{2} {S}_{( sol )} + {MCl}_{2 n ( sol )} {\to }^{RT , 1 atm} {MS}_{n ( s )} + 2 {n LiCl}_{( sol )} Δ {G}^{o} ⪡ 0 kJ \text{/} mol . \qquad ( 10 )$$

When the second metathesis reaction is conducted in a polar aprotic solvent (e.g., THF, DMF, acetonitrile, etc.) the MSₙ product precipitates from solution, while LiCl remains dissolved in the solution. Reaction (10) regenerates LiCl which can be recovered via solvent evaporation and used in reaction (9). Many examples of MSₙ synthesis via Reaction (10) have been demonstrated and can be found in R. R. Chianelli, M. B. Dines, “Low-Temperature Solution Preparation of Group 4B, 5B and 6B Transition-Metal Dichalcogenides”, Inorg. Chem. 17, 2758 (1978); R. R. Chianelli, E. B. Prestridge, T. A. Pecoraro, J. P. Deneufville, “Molybdenum Disulfide in the Poorly Crystalline “Rag” Structure”, Science 203, 1105 (1979); and T. Pecoraro, R. R. Chianelli, “Hydrodesulfurization catalysis by transition metal sulfides” J. of Catal. 67, 430 (1981) (each of which is incorporated herein in their entirety).

Alternatively, the second metathesis could be conducted thermally without solvent using the solid-state method described herein.

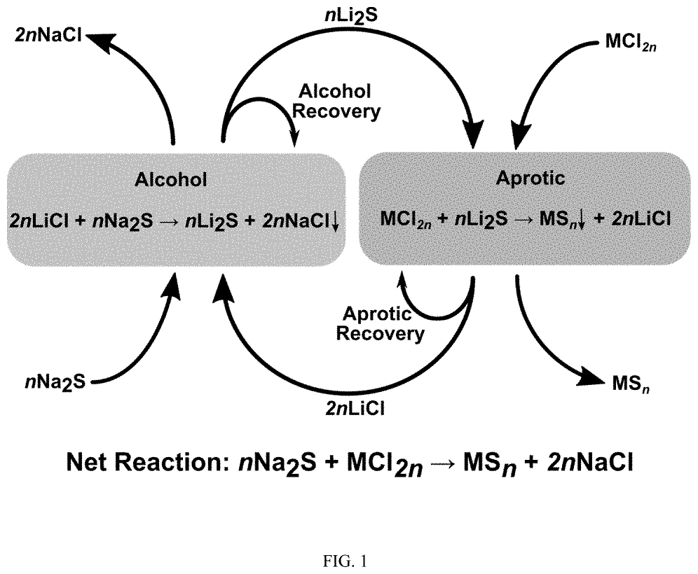

The central thesis of this approach is to couple reactions (9) and (10), or the analogous solid-state reactions, to enable the cascaded metathesis of innumerable metal sulfides using Li compounds as recycled intermediates. This reaction sequence is shown in FIG. 1. The net reaction is:

$$n {Na}_{2} S + {MCl}_{2 n} {\to }^{RT , 1 atm} {MS}_{n} + 2 n NaCl Δ {G}^{o} ⪡ 0 kJ \text{/} mol . \qquad ( 11 )$$

The direct implementation of reaction (11) is commonly utilized to synthesize a number of metal sulfide compounds. The key benefits of the cascaded metathesis approach, rather than the direct approach, are threefold: First, the cascaded approach allows for the removal of the lithium salt byproduct from the product using a nonprotic or weakly protic solvent. In the direct approach, the salt byproduct is typically NaCl, which can only be removed by dissolving in strongly protic solvents such as water, methanol, or ethylene glycol. Many metal sulfides and/or their metal chloride precursors cannot tolerate strongly protic solvents such as those listed above because of their tendency to undergo hydrolysis. Therefore, in some cases, it is beneficial to form LiCl as the byproduct rather than NaCl due to the high solubility of LiCl in nonprotic or weakly protic polar solvents. These solvents, such as tetrahydrofuran or dimethylformamide, can be tolerated by many metal sulfides/chlorides. The second benefit is that the use of nonprotic or weakly protic solvents can impart a unique morphology or particle size distribution to the MSₙ product, which may be beneficial for certain applications. These morphologies are often not accessible when using the direct approach. The third benefit is that the net reaction achieves the previous two advantages with no net consumption of lithium, which could be prohibitively expensive.

The reagents involved are low cost salts and the reactions are preferably spontaneously, proceeding to completion under ambient conditions or near ambient conditions in solution. The only significant energy requirements are those associated with the vaporization of volatile organic solvents for the recovery of the Li intermediates. The solvents may be readily condensed and recycled and the MSₙ product may be directly recovered in nanocrystal form.

By coupling reactions (9) and (10), Li₂S can be formed and then be used to facilitate the synthesis other metal or metalloid sulfides of interest. By way of non-limiting examples, the following metal or metalloid sulfides can be produced from Li₂S:

2Li₂S₍ₛ₎+SnCl₄₍ₛₒₗ₎→SnS₂₍ₛ₎+4LiCl₍ₛₒₗ₎ΔG°=−382 kJ/mol; (12)

2Li₂S₍ₛ₎+SiCl₄₍ₛₒₗ₎→SiS₂₍ₛ₎+4LiCl₍ₛₒₗ₎ΔG°=−248 kJ/mol; (13)

3Li₂S₍ₛ₎+2AlCl₃₍ₛₒₗ₎→Al₂S₃₍ₛ₎+6LiCl₍ₛₒₗ₎ΔG°=−449 kJ/mol; (14)

Li₂S₍ₛ₎+CaCl₂₍ₛₒₗ₎→CaS₍ₛ₎+2LiCl₍ₛₒₗ₎ΔG°=−56 kJ/mol (15); and

Li₂S₍ₛ₎+MgCl₂₍ₛₒₗ)→MgS₍ₛ₎+2LiCl₍ₛₒₗ₎ΔG°=−77 kJ/mol. (16)

These reactions are all highly thermodynamically favorable, driven by the exothermicity of salt precipitation. Examples of metal or metalloid sulfides that may be formed using the cascaded metathesis approach are Cr₂S₃, MnS, ReS₂, FeS₂, RuS₂, OsS₂, CoS₂, RhS₂, IrS₃, NiS₂, PdS, PtS, HfS₂, NbS₂, TaS₂, GeS₂, SiS₂, TiS₂, SnS₂, MoS₂, ZrS₂, CdS, ZnS, VS₂, WS₂, Al₂S₃, CaS, and MgS.

While the above reaction sequence has been disclosed with some degree of specificity, one skilled in the art will understand that other reactants may be employed. In addition, the reaction conditions (e.g., temperature and pressure) may be varied to optimize the production of the Li₂S and/or MSₙ nanocrystals. The reactions disclosed herein may conducted in a batch process or in a continuous process.

### Example 1: Formation of Li₂S Nanocrystals by Solution-Based Metathesis

Li₂S nanocrystals were formed using the following solution-based method:
(1) a first solution was prepared by dissolving anhydrous Na₂S in ethanol at an approximate concentration of 10 g/100 g;
(2) a second solution was prepared by dissolving anhydrous LiCl in ethanol at an approximate concentration of 20 g/100 g;
(3) a stoichiometric amount of the first solution was added to the second solution and stirred for approximately 60 minutes, where the following reaction occurred: 2LiCl(sol)+Na₂S(sol) Li₂S(sol)+2NaCl(s);
(4) the solution was centrifuged, and the supernatant was decanted;
(5) the precipitate was dried at about T=150° C. under argon gas;
(6) the supernatant was evaporated at about T=100° C. under a flow of argon gas to obtain a powder; and
(7) the obtained powder was annealed at 250° C. for 2 hours under flow of argon gas.

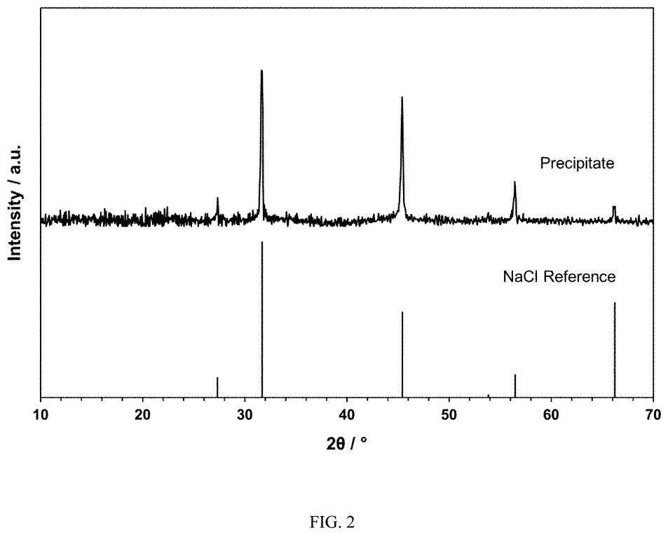

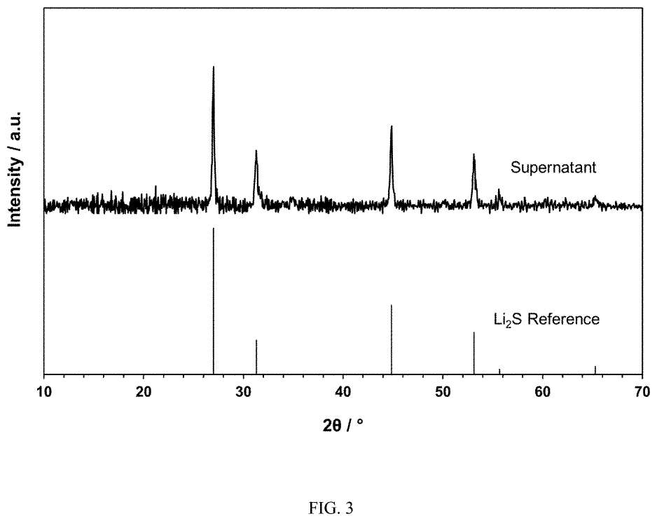

The resulting powders obtained from the above method were analyzed using X-ray diffraction (XRD) using a Philips X′Pert X-ray diffractometer with Cu Kα radiation (λ=0.15405 nm) between 10 and 70° at a scan rate of 5° min⁻¹. Samples were prepared on a glass slide with a piece of Scotch Magic Tape covering the material to prevent undesired reactions with ambient moisture. The contribution from the glass slide was background subtracted with a polynomial fit. FIG. 2 shows the reference XRD pattern of NaCl with the experimental diffraction pattern of the powder obtained from the precipitate after drying at 150° C. FIG. 3 shows the reference XRD pattern of anhydrous Li₂S with the experimental diffraction pattern of the powder obtained from the supernatant after annealing at 250° C.

### Example 2: Formation of Li₂S Nanocrystals by Solid-State Metathesis

Li₂S nanocrystals were formed using the following solid-state method:
(1) a stoichiometric amount of anhydrous LiCl was mixed with anhydrous Na₂S by mortar and pestle;
(2) the solid mixture was heated to about 600° C. under argon gas flow for about 2 hours;
(3) the resulting product mixture was ground with mortar and pestle and mixed with ethanol at a concentration of about 22 g solid/100 g ethanol.
(4) the solution was centrifuged, and the supernatant was decanted;
(5) the precipitate was dried at about T=150° C. under argon gas;
(6) the supernatant was evaporated at about T=100° C. under a flow of argon gas to obtain a powder; and
(7) the obtained powder was annealed at 250° C. for 2 hours under flow of argon gas.

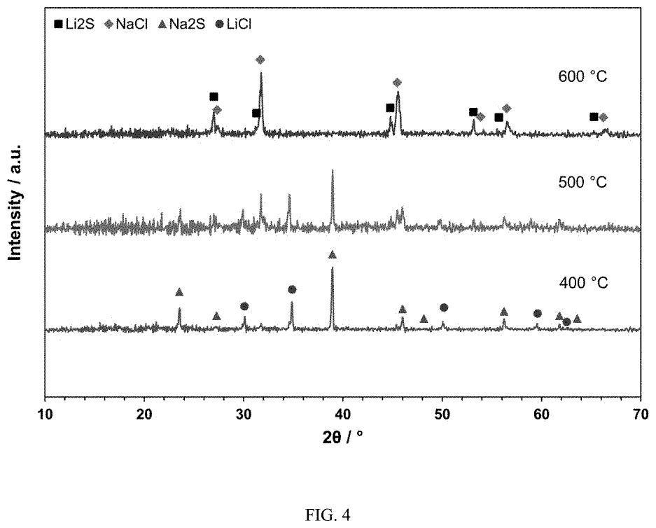

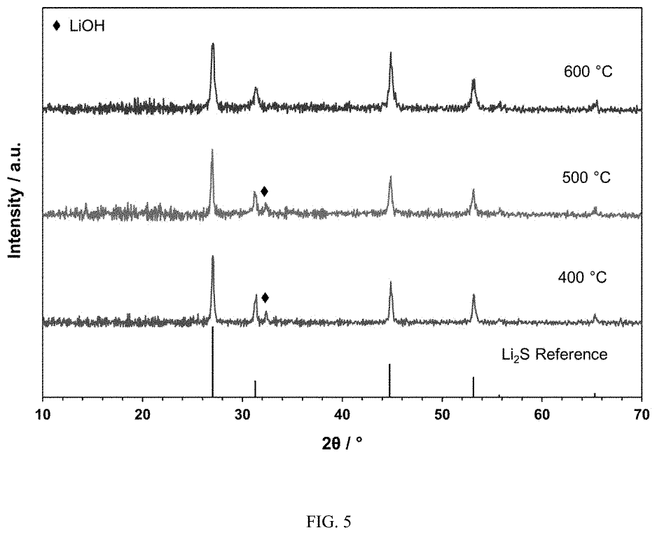

The resulting powders obtained from the above method after step (2) were analyzed using XRD using the previously described method. FIG. 4 shows experimental XRD pattern of the solid product mixture after reaction at different temperatures, 400° C., 500° C., and 600° C. The peaks associated with LiCl, Na₂S, NaCl, and Li₂S are identified in legend. FIG. 5 shows the experimental XRD pattern of the products recovered from supernatant (step 7) after dissolving the solid-state products formed as a function of temperature. The reference pattern of Li₂S is provided, and the peaks associated with LiOH are identified in legend.

Various modifications of the above-described invention will be evident to those skilled in the art. It is intended that such modifications are included within the scope of the following claims.

1. A method of producing Li₂S comprising:
mixing a first sulfide salt and a first lithium salt;
allowing sufficient time to form Li₂S and a product salt; and
recovering the Li₂S.

2. The method of claim 1, wherein the first sulfide salt and the first lithium salt are mixed in a first solution, wherein the product salt is insoluble in or only sparingly soluble in the first solution, and wherein the product salt is separated from the first solution prior to recovering the Li₂S.

3. The method of claim 2, wherein the first solution comprises a polar solvent having a boiling point of about 150° C. or less, and wherein the Li₂S is recovered via solvent evaporation in an inert atmosphere or in the presence of H₂S.

4. The method of claim 2, wherein the first sulfide salt and the first lithium salt spontaneously react to form the Li₂S at room temperature.

5. The method of claim 1, wherein the first sulfide salt and the first lithium salt are mixed, without the addition of a solvent, and the mixture is heated to a temperature of at least 400° C., wherein the Li₂S and the product salt are added to a first solution, wherein the product salt is insoluble in or only sparingly soluble in the first solution, and wherein the product salt is separated from the first solution prior to recovering the Li₂S.

6. The method of claim 5, wherein the first solution comprises a polar solvent having a boiling point of about 150° C. or less, and wherein the Li₂S is recovered via solvent evaporation in an inert atmosphere or in the presence of H₂S.

7. The method of claim 1, further comprising annealing the recovered Li₂S at a temperature of about 150° C. to about 300° C. in an inert atmosphere or in the presence of H₂S.

8. The method of claim 1, wherein the Li₂S is in the form of nanocrystals have a volume-averaged mean particle size (D₅₀) from 5 nm to 50 nm.

9. The method of claim 1, wherein the first sulfide salt is selected from the group consisting of Na₂S, K₂S, Rb₂S, Cs₂S, Fr₂S, (NH₄)₂S, P₂S₅, NiS, and combinations thereof.

10. The method of claim 1, wherein the first lithium salt is selected from the group consisting of a lithium halide, lithium hydroxide (LiOH), lithium carbonate (Li₂CO₃), lithium sulfate (Li₂SO₄), lithium sulfite (Li₂SO₃), lithium amide (LiNH₂), lithium nitride (LiN₃), lithium nitrate (LiNO₃), lithium phosphate (Li₃PO₄), and combinations thereof.

11. The method of claim 1, further comprising:
mixing the recovered Li₂S and a non-lithium containing salt;
allowing sufficient time to form a metal or metalloid sulfide (MSₙ) and a second lithium salt; and
recovering the MSₙ.

12. The method of claim 11, wherein the recovered Li₂S and non-lithium containing salt are mixed in a second solution, wherein the MSₙ is insoluble in or only sparingly soluble in the second solution, wherein the MSₙ is separated from the second solution.

13. The method of claim 12, wherein the second solution comprises a polar aprotic solvent having a boiling point of about 150° C. or less.

14. The method of claim 11, wherein the recovered Li₂S and non-lithium containing salt are mixed, without the addition of a solvent, and the mixture is heated to a temperature of at least 400° C., wherein the MSₙ and the product salt are added to a second solution, wherein the MSₙ is insoluble in or only sparingly soluble in the second solution, and wherein the MSₙ is separated from the second solution.

15. The method of claim 14, wherein the second solution comprises a polar aprotic solvent having a boiling point of about 150° C. or less.

16. The method of claim 11, wherein the non-lithium containing salt comprises a metal or metalloid cation and an anion selected from the group consisting of a halide, hydroxide, carbonate, sulfate, sulfite, nitrate, nitrite, phosphate, acetate, citrate, and combinations thereof.

17. The method of claim 11, wherein the MSₙ is selected from the group consisting of Cr₂S₃, MₙS, ReS₂, FeS₂, RuS₂, OsS₂, CoS₂, RhS₂, IrS₃, NiS₂, PdS, PtS, HfS₂, NbS₂, TaS₂, GeS₂, SiS₂, TiS₂, SnS₂, MoS₂, ZrS₂, CdS, ZnS, VS₂, WS₂, Al₂S₃, CaS, and MgS.

18. The method of claim 11, further comprising recovering the second lithium salt and recycling the second lithium salt second to be used as the first lithium salt.

19. A method of producing Li₂S nanocrystals comprising:
mixing a first sulfide salt and a first lithium salt in a first solution comprising a polar solvent;
allowing sufficient time to form Li₂S and a product salt precipitate;
separating the product salt precipitate from the first solution;
recovering the Li₂S via solvent evaporation, and
annealing the recovered Li₂S at a temperature of about 150° C. to about 250° C., wherein the Li₂S is in the form of nanocrystals have a volume-averaged mean particle size (D₅₀) from 5 nm to 50 nm.

20. A method of producing metal or metalloid sulfide (MSₙ) nanocrystals comprising:
mixing a first sulfide salt and a first lithium salt in a first solution comprising a polar solvent;
allowing sufficient time to form Li₂S and a product salt precipitate;
separating the product salt precipitate from the first solution;
recovering the Li₂S from the first solution;
mixing the recovered Li₂S with a non-lithium containing salt in a second solution comprising a polar aprotic solvent;
allowing sufficient time to form MSₙ nanocrystals and a second lithium salt; and
recovering the MSₙ nanocrystals from the second solution,
wherein the MSₙ nanocrystals are selected from the group consisting of Cr₂S₃, MₙS, ReS₂, FeS₂, RuS₂, OsS₂, CoS₂, RhS₂, IrS₃, NiS₂, PdS, PtS, HfS₂, NbS₂, TaS₂, GeS₂, SiS₂, TiS₂, SnS₂, MoS₂, ZrS₂, CdS, ZnS, VS₂, WS₂, Al₂S₃, CaS, and MgS.
